(19) United States
(12) Patent Application Publication
(10) Pub. No.: US 2026/0208875 A1
(43) Pub. Date: Jul. 23, 2026

(54) Systems and Methods to Jettison Fuel from an Aircraft

(71) Applicant: The Boeing Company, Arlington, VA (US)

(72) Inventors: William Rohan Drummond, Torrance, CA (US); Thomas Skyler Sartorius, San Luis Obispo, CA (US); Daniel Alan Watts, Surfside, CA (US); Aaron Jonathan Kutzmann, Long Beach, CA (US)

(21) Appl. No.: 19/035,027

(22) Filed: Jan. 23, 2025

(51) Int. Cl. B64D 37/26; B64C 3/34

(52) U.S. Cl. CPC B64D 37/26; B64C 3/34

(57) ABSTRACT

A system to jettison fuel from an aircraft. The system includes one or more fuel tanks configured to contain the fuel in a pressurized state. Fuel lines extend from the one or more fuel tanks with the fuel lines configured to move the fuel while in a gaseous state. A nozzle is connected to one of the fuel lines with the nozzle having a passage that moves the fuel along a length of the nozzle and out through a distal end of the nozzle.

### TECHNOLOGICAL FIELD

The present disclosure relates generally to the field of aircraft and, more specifically, to systems and methods to jettison fuel from an aircraft.

### BACKGROUND

Aircraft engines can be powered by various types of fuel. The fuel is stored in one or more tanks that are mounted on the aircraft. The fuel system extends between the fuel tanks and the engines to supply the fuel. The amount of fuel that is stored in the fuel tanks can vary depending upon different aspects including but not limited to the size of the aircraft and the amount of flying time since that last refuel.

There are events with the aircraft that could occur in which jettisoning the fuel from the aircraft would be a benefit. One example of an event is a landing gear failure during flight in which the landing gear does not deploy. This event would result in the underside of the fuselage contact against the runway during landing. There could be an issue with sparks, heating, or crushing of the fuselage that could be an issue for the fuel, particularly if the fuel tanks are located in a lower section of the fuselage. Another example of an event is an aircraft that is located in the vicinity of a fire while the aircraft is on the ground. For these types of events, it could be beneficial for the fuel to be jettisoned from the aircraft to dissipate the potential energy of the fuel that is stored in the aircraft.

A jettison system should be configured to eject the fuel away from the aircraft. This includes directing the fuel away from areas of the aircraft that could be an issue, such as away from the intake to the engines, and air intakes such as for an aircraft environmental system. Further, the fuel may need to be directed in different directions depending on the environment. For example, the fuel may need to be directed in a first direction when the aircraft is positioned on the ground and a different second direction when the aircraft is in flight.

### SUMMARY

One aspect is directed to a system to jettison fuel from an aircraft. The system comprises one or more fuel tanks configured to contain the fuel in a pressurized state. Fuel lines extend from the one or more fuel tanks with the fuel lines configured to move the fuel while in a gaseous state. A nozzle is connected to one of the fuel lines with the nozzle comprising a passage that moves the fuel along a length of the nozzle and out through a distal end of the nozzle.

In another aspect, the nozzle is movable between a stowed position with the distal end positioned in proximity to the aircraft and a deployed position with the distal end extending outward away from the aircraft.

In another aspect, a receptacle is positioned on an exterior of the aircraft and sized to contain the nozzle in the stowed position for the nozzle to be out of an airflow during flight.

In another aspect, the fuel lines extend to one or more engines mounted to the aircraft with the one or more engines configured to propel the aircraft during flight.

In another aspect, a drag bar is mounted to the nozzle with the drag bar comprising one or more surfaces that are contacted by airflow and cause the nozzle to move to the deployed position during flight of the aircraft.

In another aspect, an igniter is positioned at the distal end of the nozzle with the igniter configured to ignite the fuel at the distal end of the nozzle.

In another aspect, the one or more fuel tanks store the fuel in the pressurized state that is at least twice ambient pressure.

In another aspect, a spring applies a biasing force to the nozzle to bias the nozzle towards the deployed position, a latch engages with the nozzle to maintain the nozzle at the deployed position, and an actuator is configured to release the latch to enable the biasing force of the spring to move the nozzle to the deployed position.

In another aspect, one or more valves are located along the fuel lines with each of the valves configured to be movable between a closed position and an open position to control a flow of the fuel through the fuel lines.

One aspect is directed to a system to jettison fuel from an aircraft. The system comprises one or more fuel tanks configured to store pressurized fuel. A nozzle is mounted to the aircraft and comprises a passage that extends through the nozzle and terminates at a distal end of the nozzle. Fuel lines distribute the fuel through the aircraft with the fuel lines extending between the one or more fuel tanks to one or more engines that propel the aircraft during flight and to the nozzle. An igniter is positioned at the nozzle to ignite the fuel that is being ejected from the nozzle.

In another aspect, an actuator is connected to the nozzle and configured to enable the nozzle to move from a stowed position with the distal end located in proximity to the aircraft and a deployed position with the distal end located away from the aircraft to eject the fuel away from the aircraft.

In another aspect, the actuator is a pneumatic actuator that comprises a housing and a plunger and wherein the one of the fuel lines is connected to the housing to move fuel into an interior of the housing to move the actuator between a first position to locate the nozzle in the stowed position and a second position to locate the nozzle in the deployed position.

In another aspect, one of the fuel lines that is connected to the nozzle comprises a kink with an angle and wherein the fuel line is configured to straighten the kink and increase the angle when the fuel moves through the kink and apply a force to move the nozzle from the stowed position to the deployed position.

In another aspect, the one or more fuel tanks and the fuel lines are configured to contain the fuel in a gaseous state.

In another aspect, one or more regulators are located on the fuels lines to control the fuel that is supplied to the engines and one or more valves located on the fuel lines and selectively positionable to control a flow of the fuel that moves along the fuel lines.

In another aspect, the system is configured to move the fuel along the fuel lines through pressure and without a fuel pump.

One aspect is directed to a method of jettisoning fuel from an aircraft. The method comprises: storing pressurized fuel in one or more fuel tanks that are on the aircraft; moving the fuel while in a gaseous state through one or more fuel lines that extend through the aircraft; moving the fuel in the gaseous state through a nozzle that is attached to the aircraft; and jettisoning the gaseous fuel from a distal tip of the nozzle and away from the aircraft.

In another aspect, the method further comprises igniting the fuel in the gaseous state while the fuel is being jettisoned from the distal tip of the nozzle.

In another aspect, the method further comprises moving a portion of the fuel into an actuator that is operatively connected to the nozzle and moving the nozzle from a stowed position to a deployed position.

In another aspect, the method further comprises jettisoning the gaseous fuel from one of a fuselage and a wing of the aircraft.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric diagram of an aircraft.

FIG. 2 is a side schematic diagram of a fuselage of an aircraft that includes fuel tanks positioned along a lower deck.

FIG. 3 is a schematic diagram of a jettison system that ejects fuel that is stored in one or more fuel tanks of an aircraft.

FIG. 4 is a schematic diagram of a jettison system that ejects fuel from a fuselage of an aircraft.

FIG. 5 is a schematic diagram of a jettison system that ejects fuel from an aft end of an aircraft.

FIG. 6 is a schematic diagram of a jettison system that ejects fuel from a tail section of an aircraft.

FIG. 7 is a schematic diagram of a jettison system that ejects fuel from a wing of an aircraft.

FIG. 8 is a schematic diagram of a nozzle connected to a fuel line and movable between the stowed position and the deployed position.

FIG. 9 is a schematic diagram of a drag bar mounted to the distal end of the nozzle.

FIG. 10A is a schematic diagram of a pneumatic actuator that is connected to the fuel line and with the pneumatic actuator in a first position.

FIG. 10B is a schematic diagram of the pneumatic actuator of FIG. 10A now in a second position.

FIG. 10C is a schematic diagram of the pneumatic actuator of FIGS. 10A and 10B connected to a nozzle.

FIG. 11A is a schematic diagram of the fuel line that includes a kink at a connection with the nozzle in the stowed position.

FIG. 11B is a schematic diagram of the kink in the fuel line now in a straighter configuration with the nozzle in the deployed position.

FIG. 12 is a schematic diagram of an igniter mounted at a distal end of the nozzle.

FIG. 13 is a schematic diagram of a computing device.

FIG. 14 is a flowchart diagram of a method of jettisoning fuel from an aircraft.

FIG. 15 is a flowchart diagram of a method of jettisoning fuel from an aircraft.

### DETAILED DESCRIPTION

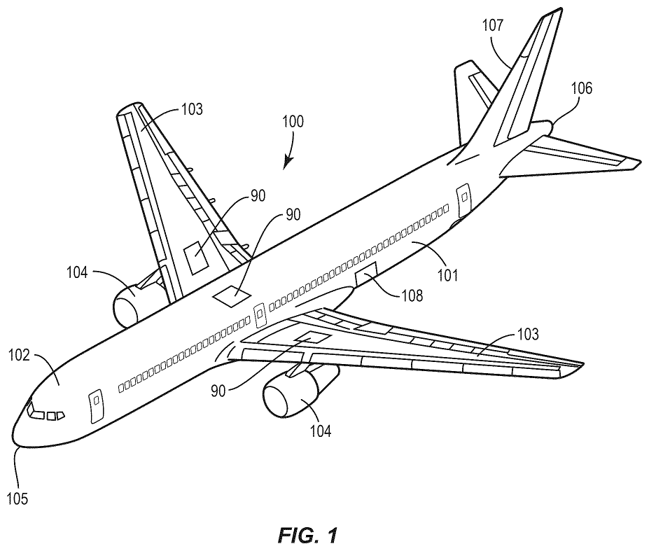

FIG. 1 illustrates an aircraft 100 configured to transport passengers and/or cargo. The aircraft 100 generally includes a fuselage 101 with an interior space configured to accommodate passengers and/or cargo. Engines 104 are mounted on the wings 103 on opposing sides of the fuselage 101. A forward end 105 of the fuselage 101 includes a flight deck 102 with various controls to enable flight personnel to control the aircraft 100. An aft end 106 of the fuselage 101 includes a tail section 107. Landing gear 108 is configured mounted at the bottom of the fuselage 101 and movable between stowed and deployed positions.

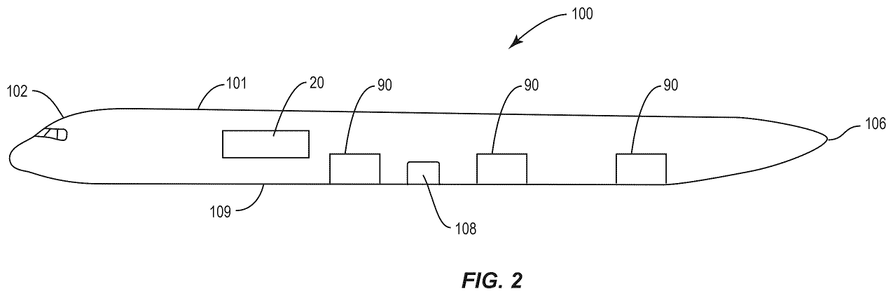

One or more fuel tanks 90 store fuel that is used by the engines 104. The fuel tanks 90 can be mounted at various positions within the aircraft 100 including but not limited within the fuselage 101 and wings 103. FIG. 1 includes an example with fuel tanks 90 that are aligned with the wings 103 and include a center fuel tank 90 positioned at the fuselage 101 and wing fuel tanks 90 positioned in the wings 103. FIG. 2 illustrates an example with fuel tanks 90 are mounted within at lower deck of the fuselage 101.

The fuel tanks 90 are pressurized to store the fuel at an elevated pressure. In some examples, the pressure is substantially twice the ambient pressure. In another example, the pressure is about 1000 psi. In some examples, the fuel stored in the fuel tanks 90 is compressed natural gas (CNG). Other examples include but are not limited to propane and hydrogen. The fuel is in a vapor form when released from the fuel tanks 90 and delivered to the engines 104. In some examples, the fuel is stored in the fuel tanks 90 as a gaseous form. In some examples, the fuel is stored in a liquid form due to the high pressure and then vaporizes into a gas when released from the fuel tanks 90.

The pressurized fuel stored in the fuel tanks 90 have a high potential energy that could be an issue if the aircraft 100 were to become involved in an event. Examples of events include but are not limited to a failure of the landing gear during flight and being in a ground fire while on the ground. In these events the fuel is jettisoned from the aircraft 100.

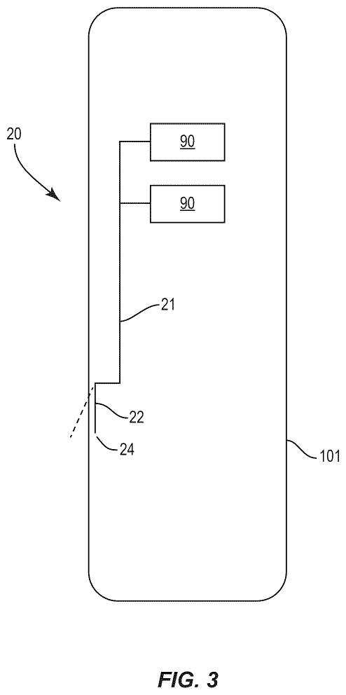

FIG. 3 schematically illustrates a jettison system 20 configured to unload fuel from the aircraft 100. The jettison system 20 includes fuel lines 21 that lead from the fuel tanks 90 to a nozzle 22. In some examples, the nozzle 22 is fixedly mounted to the aircraft 100 and does not move to different positions. In other examples as illustrated in FIG. 3 the nozzle 22 is movable between a stowed position (shown in solid lines) and a deployed position (shown in dashed lines). The nozzle 22 is in the stowed position when the jettison system 20 is not in use and in the deployed position to locate the distal end 24 of the nozzle 22 outward to discharge the fuel away from the aircraft 100.

The jettison system 20 is configured to eject the fuel from one or more different locations on the aircraft 100. Examples include but are not limited to the fuselage 101, the wings 103, a horizontal stabilizer, and the tail section 107. In some examples, the nozzle 22 is positioned in one or more fairings that are flush with the fuselage outer mold lines. In some examples, the jettison system 20 is configured to jettison the fuel from a single location on the aircraft 100. In other examples, the jettison system 20 dispels the fuel from two or more different locations on the aircraft 100. The jettison system 20 is configured to prevent the fuel from being dispelled at a location that could cause an issue with operation of the aircraft 100 such as but not limited to in front of an engine 104, into an air intake for the environmental system and air intake for the auxiliary power unit (APU).

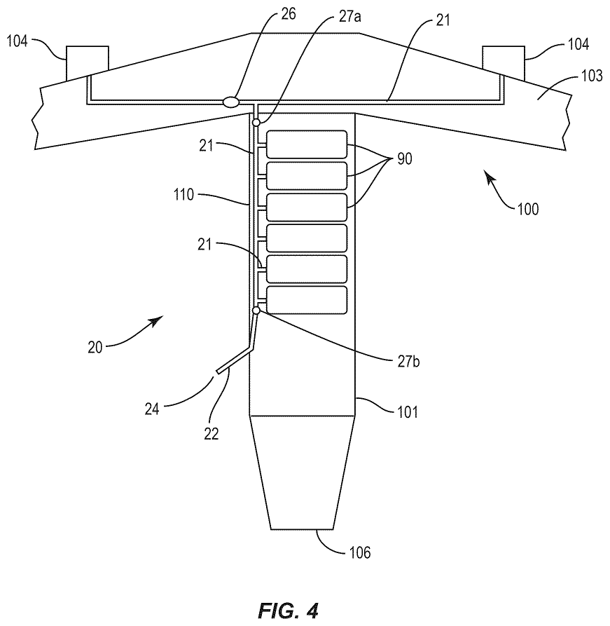

FIG. 4 illustrates an example with the jettison system 20 configured to jettison the fuel from the fuselage 101. The fuel lines 21 extend from the fuel tanks 90 to the engines 104. In this example, the fuel lines 21 include separate feeder lines that extend from each fuel tank 90 and a common manifold.

One or more regulators 26 maintain a consistent fuel pressure to the fuel that is supplied to the engines 104. The jettison system 20 includes one or more valves 27 to control the movement of fuel. The valves 27 are movable between various positions from a closed position that prevents flow through the fuel line 21 and an open position that allows flow through the fuel line 21. In some examples as illustrated in FIG. 4, the jettison system 20 includes two valves 27a, 27b. Valve 27a is positioned to control the fuel flow to the engines 104. Valve 27b is positioned between the fuel tanks 90 and the nozzle 22 and is closed to control the fuel flow through the nozzle 22.

The nozzle 22 is mounted at the lateral side 110 of the fuselage 101. The nozzle 22 is located aft of the engine 104 and away from the air intakes. The fuel is pressurized and in a gaseous state while moving through the fuel lines 21. The pressurization of the fuel enables the fuel to flow through the fuel lines 21 without the need for fuel pumps. The pressurized fuel moves towards the lower ambient pressure at the ends of the fuel lines 21.

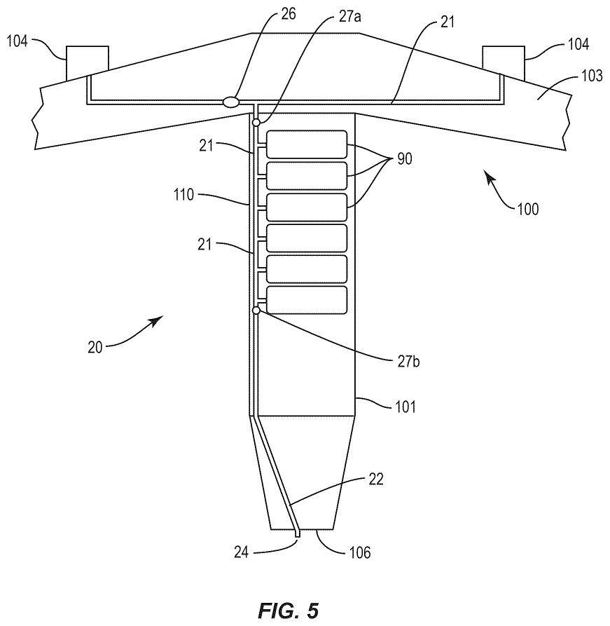

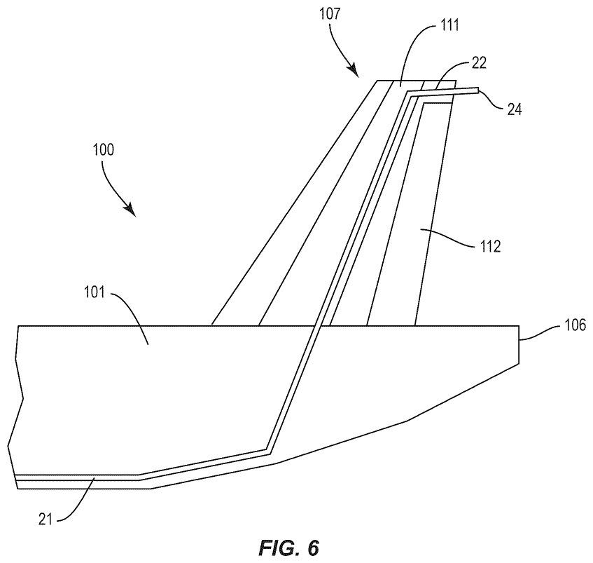

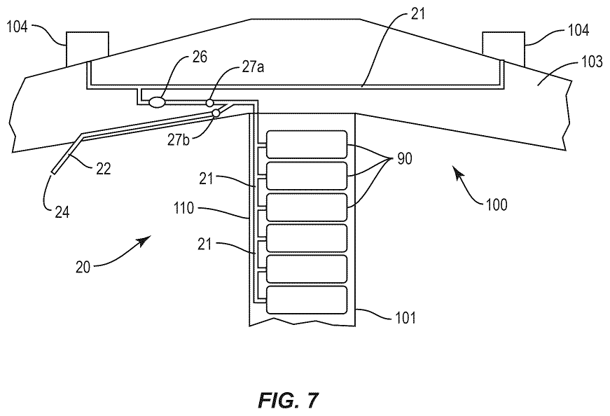

FIG. 5 illustrates a jettison system 20 that expels the fuel from the aft end 106 of the aircraft 100. The nozzle 22 is positioned with the distal end 24 extending outward beyond the fuselage 101. FIG. 6 illustrates an example with the nozzle 22 mounted to the tail section 107. The fuel line 21 extends along the fuselage 101 and into the vertical stabilizer 111 of the tail section 107. The nozzle 22 extends outward from the vertical stabilizer 111 above the rudder 112. FIG. 7 includes a jettison system 20 that expels the fuel from an aft edge of the wing 103 and away from the engine 104.

The amount of time needed to empty to the one or more fuel tanks 90 can vary. In one example that includes six fuel tanks 90 each with an internal volume of 358370.1 in³ and fuel lines 21 with a one inch (1″) diameter, the time needed to jettison the fuel is substantially four minutes. In this example, the jettison system 20 operates with adiabatic conditions, there is no friction on the fuel after being expelled from the nozzle 22, and the fuel tanks 90 are at a constant temperature. The operating conditions of this example include the fuel being compressed natural gas (CNG) stored at a tank pressure of 3600 psi and a starting temperature of the CNG fuel at 70° F. Further, the jettison system 20 does not include any fuel pumps.

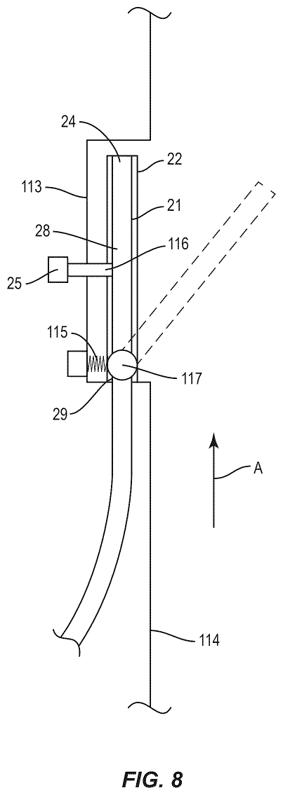

The nozzle 22 is positioned on the fuel line 21 and configured to dispel the fuel from the aircraft 100. The nozzle 22 can include a variety of different shapes and configurations. FIG. 8 illustrates an example of a nozzle 22 that includes an elongated shape with a first end 29 and an opposing second distal end 24. In some examples, a passage 28 extends through the nozzle 22 and is sized to receive the fuel line 21. In other examples, the nozzle 22 includes a conduit that receives the fuel from the fuel line 21 and delivers the fuel to the distal end 24. A connector or clamp can be positioned at the first end 29 of the nozzle 22 to connect to the fuel line 21.

In some examples, a linkage 117 connects the first end 29 of the nozzle 22 to the aircraft 100. The linkage 117 is configured to enable movement of the nozzle 22 between the stowed position and the deployed position. In some examples, one or more springs 115 bias the nozzle 22 towards the deployed position. A latch 116 connects the nozzle 22 to maintain the nozzle 22 in the stowed position. To deploy the nozzle 22, an actuator 25 releases the latch 116 enabling the nozzle 22 to move from the stowed position towards the deployed position. In some examples, the actuator 25 is activated with a signal that is sent from flight personnel in the flight deck 102. The actuator 25 can include a variety of different configurations, including but not limited to a solenoid. In one example, the actuator 25 includes a motor that can move the nozzle 22 between the stowed position and the deployed position.

In some examples when the nozzle 22 is in the stowed position as illustrated in FIG. 8, the nozzle 22 is located in a receptacle 113 on the aircraft 100 such as the fuselage 101. The receptacle 113 protects the nozzle 22 from the airflow shown by arrow A during flight. In some examples, the receptacle 113 is formed in a fairing that is attached to the aircraft 100.

In some examples, the nozzle 22 is configured to have different deployed positions depending upon the situation. During flight, the deployed position provides for the fuel to be dispelled downward and away from the aircraft 100. When the aircraft 100 is on the ground, the deployed position dispels the fuel upward to prevent the fuel from being dispelled onto a ground fire and/or any persons that are on the ground in the vicinity of the aircraft 100. In some examples, the nozzle 22 is designed to be passively positioned at the applicable deployed position after being deployed by the flight personnel.

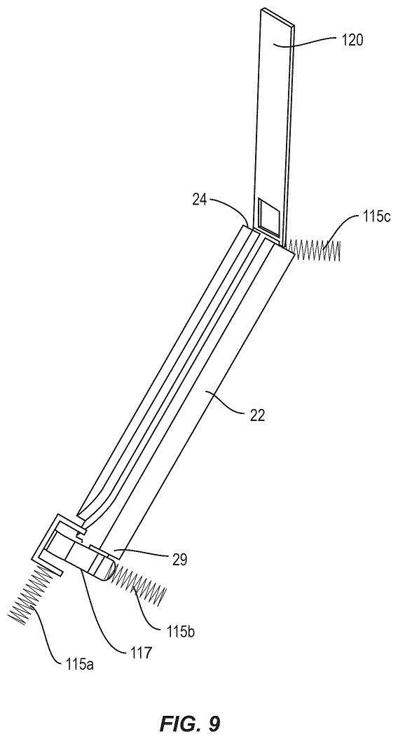

FIG. 9 illustrates a nozzle 22 configured to locate the distal end 24 at the proper position depending upon the environment. Multiple springs 115 cause deployment and positioning. In some examples, each of the springs 115 is located at a pin joint to locate the nozzle 22 along a different axis and away from the aircraft 100. In this example, a first spring 115a applies a force to rotate a linkage 117 at the first end 29 of the nozzle 22. A second spring 115b is connected at the first end 29 to rotate the nozzle about a second axis.

In some examples, a drag bar 120 is mounted to the nozzle 22 and extends outward beyond the distal end 24. The drag bar 120 includes one or more surfaces that are contacted by the airflow. During flight, the airflow acts on the surfaces and causes a drag force that positions the distal end 24 to dispel the fuel downward. When the aircraft is on the ground, less or no airflow acts of the surfaces resulting in the nozzle 22 being oriented in a different deployed position. This ground deployed position locates the distal end 24 to dispel the fuel upward. This configuration enables the passive positioning of the nozzle 22 to dispel the fuel in the desired direction without input from the flight personnel after activating the actuator 25.

In some examples, the drag bar 120 is pivotally connected to the distal end 24 of the nozzle 22. In the stowed position, the drag bar 120 is folded and overlaps with the nozzle 22. In the deployed position, the drag bar 120 pivots outward away from the nozzle 22. A spring 115c applies a biasing force to deploy the drag bar 120 when the nozzle is moved from the stowed position.

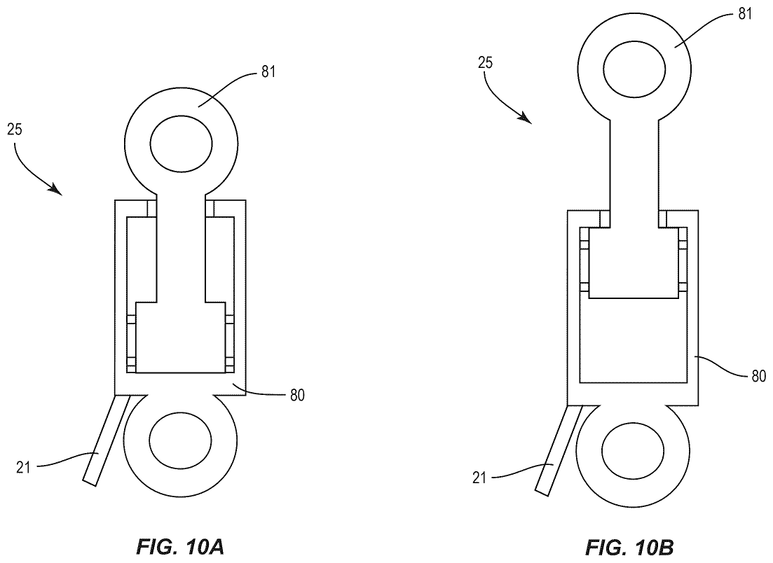

In some examples the actuator 25 is a pneumatic actuator 25 as illustrated in FIGS. 10A and 10B. The pneumatic actuator 25 includes a housing 80 and a plunger 81. The housing 80 is connected to the fuel line 21 that delivers the fuel to the nozzle 22. One or more seals are connected to the body of the plunger 81. When the actuator 25 is activated such as by a command from flight personnel, fuel from the fuel line 21 moves into and fills the housing 80. The fuel causes the plunger 81 to move relative to the housing 80 as illustrated in FIG. 10B. In some examples as illustrated in FIG. 10C, the actuator 25 is mounted with one of the housing 80 and plunger 81 connected to the aircraft 100 and the other connected to the nozzle 22. In the deployed position as illustrated in FIG. 10C, the actuator 25 extends the nozzle 22 outward away from the aircraft 100.

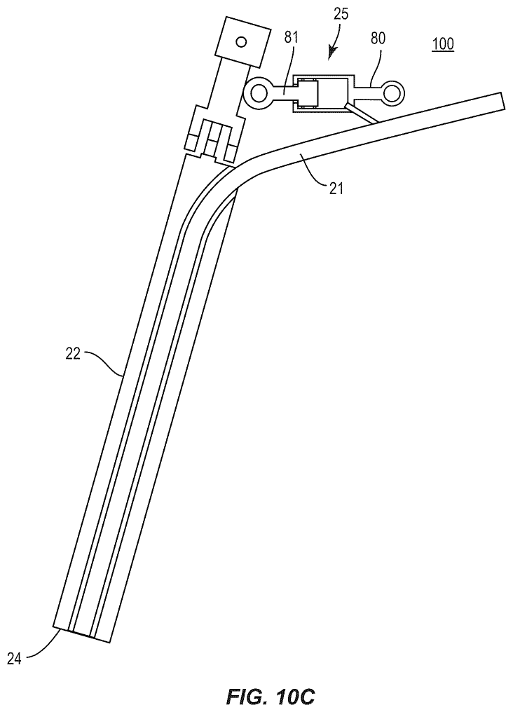

In some examples, the actuation to move the nozzle 22 to the deployed position occurs due to the flow of fuel through the fuel line 21. This movement occurs due to the configuration of the fuel line 21. FIGS. 11A and 11B include the fuel line 21 including a kink 35 with an angle a sections of the fuel line where the fuel line 21 extends into the nozzle 22. In the stowed position as illustrated in FIG. 11A, the kink 35 has an angle α. When fuel is moved through the fuel line 21, such as when a valve is opened by a command from flight personnel, the moving fuel applies a force in a direction to straighten the kink 35 (i.e., increase the angle a). This force is transferred to the nozzle 22 which causes movement to the deployed position as illustrated in FIG. 11B. The angle a of the kink 35 is greater in the deployed position as the nozzle 22 pivots outward away from the aircraft 100.

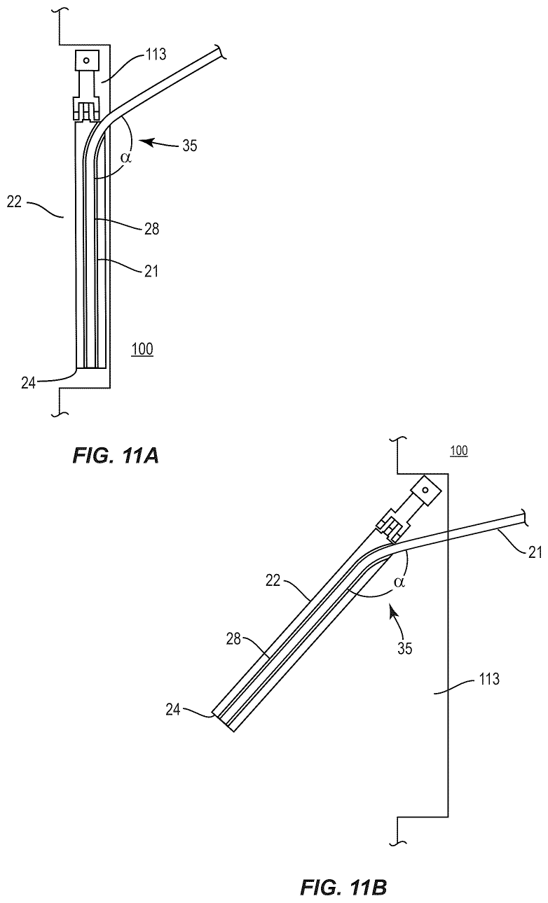

In some examples, the fuel is ejected in the gaseous state into the environment outside of the aircraft 100. In some examples, this occurs during flight when the airspeed of the aircraft 100 provides for the gaseous state to be dispersed by the airflow. In other examples, the fuel is ignited as it is being dispersed from the nozzle 22. FIG. 12 illustrates a nozzle 22 with an igniter 70 positioned at the distal end 24. The igniter 70 produces a flame or other like ignition source that ignites the gaseous fuel that is being dispelled from the distal end 24. This causes the fuel to be consumed such that it does reach the ground. In some examples, the igniter 70 is used to ignite the fuel when the aircraft 100 is on the ground to prevent the fuel from reaching a ground fire and/or persons that are on the ground in vicinity of the aircraft 100. In some examples, the igniter includes a burner tip that includes a series of holes to inject the gaseous fuel into the airflow to enable combustion. The igniter also includes the ignition source that produces a spark and/or flame to ignite the gaseous fuel. In some examples, the burner tip is configured to expel the fuel at an exit velocity to enable ignition when the aircraft 100 is in flight or on the ground. In one example with the nozzle 22 having a one inch (1″) diameter, the maximum exit velocity of the fuel is 61.36 ft/s.

In some examples, the jettison system 20 is controlled by flight personnel from the flight deck 102. A command can be entered that causes the jettison system 20 to activate and start the flow of fuel through the fuel lines 21 and to the nozzle 22 for ejection. In some examples, the command to jettison the fuel causes valves 27 at the fuel tanks 90 to open to start the flow of fuel. In other examples, the command causes one or more other valves 27 along the fuel line to open. In some examples, the command also activates the actuator 25 to move the nozzle 22 to the deployed position. In some examples, the command also activates the igniter 70 to ignite the fuel that is expelled from the aircraft 100.

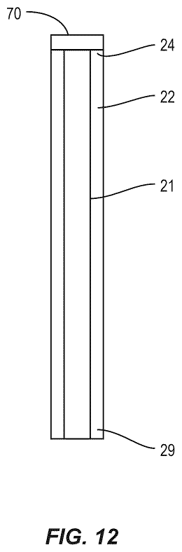

FIG. 13 illustrates a computing device 50 that controls the operation of the jettison system 20. In some examples, the computing device 50 is a stand-alone component. In some examples, the computing device 50 is incorporated into one or more other computing devices 50 on the aircraft 100 such as but not limited to a fuel control computing device and a flight control computing device.

The computing device 50 can include one or more of each of a number of components such as, for example, processing circuitry 51 (e.g., processor unit) connected to a memory circuitry 52 (e.g., storage device). The processing circuitry 51 may be composed of one or more processors alone or in combination with one or more memories. The processing circuitry 51 is generally computer hardware that is capable of processing information such as, for example, data, computer programs and/or other suitable electronic information. The processing circuitry 51 is composed of a collection of electronic circuits some of which may be packaged as an integrated circuit or multiple interconnected integrated circuits (an integrated circuit at times more commonly referred to as a “chip”). The processing circuitry 51 may be configured to execute computer programs 59 with programming instructions which may be stored onboard the processing circuitry 51 or otherwise stored in the memory circuitry 52 (of the same or another device).

The processing circuitry 51 may be a number of processors, a multi-core processor or some other type of processor, depending on the particular implementation. Further, the processing circuitry 51 may be implemented using a number of heterogeneous processor systems in which a main processor is present with one or more secondary processors on a single chip. As another illustrative example, the processing circuitry 51 may be a symmetric multi-processor system containing multiple processors of the same type. In yet another example, the processing circuitry 51 may be embodied as or otherwise include one or more ASICs, FPGAs or the like. Thus, although the processing circuitry 51 may be capable of executing a computer program to perform one or more functions, the processing circuitry 51 of various examples may be capable of performing one or more functions without the aid of a computer program. In either instance, the processing circuitry 51 may be appropriately programmed to perform functions or operations according to example implementations of the present disclosure.

The memory circuitry 52 is generally computer hardware that is capable of storing information such as, for example, data, computer programs (e.g., computer-readable program code) and/or other suitable information either on a temporary basis and/or a permanent basis. The memory circuitry 52 may include volatile and/or non-volatile memory and may be fixed or removable. Examples of suitable memory circuitry 52 include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory circuitry 52 may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

Computing device 50 also includes communications circuitry 53 configured to transmit and/or receive information, such as to and/or from other systems on the aircraft 100, the flight deck 102, and a remote node 150 that is monitoring from the ground the status of the aircraft 100. The communications circuitry 53 may be configured to transmit and/or receive information by physical (wired) and/or wireless communications links. Examples of suitable communication interfaces include a network interface controller (NIC), wireless NIC (WNIC) or the like. The communications circuitry 53 may have one or more transmitters and/or receivers. In some examples, a user interface is included to enable input from the flight personnel and associated output. The user interface can include one or more input devices such as but not limited to a keypad, touchpad, roller ball, and joystick. The user interface also includes one or more displays for displaying information regarding the fuel jettison.

As will be appreciated by those of ordinary skill in the art without undue experimentation, program code instructions 59 may be loaded onto a computing device or other programmable apparatus from a computer-readable storage medium to produce a particular machine, such that the particular machine becomes a means for implementing the functions specified herein. These program code instructions 59 may also be stored in a computer-readable storage medium that can direct a computer, a processing circuitry or other programmable apparatus to function in a particular manner to thereby generate a particular machine or particular article of manufacture. The program code instructions 59 may be retrieved from a computer-readable storage medium and loaded into a computer, processing circuitry or other programmable apparatus to configure the computing device 50, processing circuitry 61 or other programmable apparatus to execute operations to be performed on or by the computer, processing circuitry or other programmable apparatus.

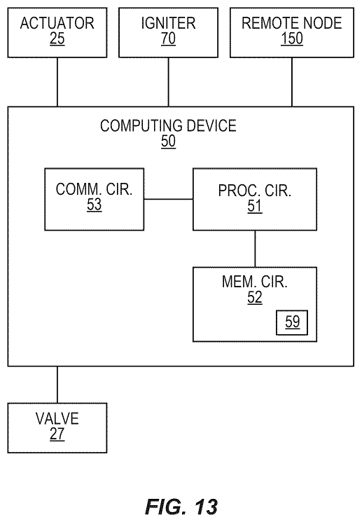

FIG. 14 illustrates a method of jettisoning fuel from an aircraft 100. The method includes storing pressurized fuel in one or more fuel tanks 90 that are on the aircraft 100 (block 300). The jettison system 20 is activated and the fuel is moved while in a gaseous state through one or more fuel lines 21 that extend through the aircraft 100 (block 302). The fuel is further moved in the gaseous state through a nozzle 22 that is attached to the aircraft 100 (block 304). The fuel is jettisoned while in the gaseous fuel from a distal tip of the nozzle 22 and away from the aircraft 100 (block 306). D

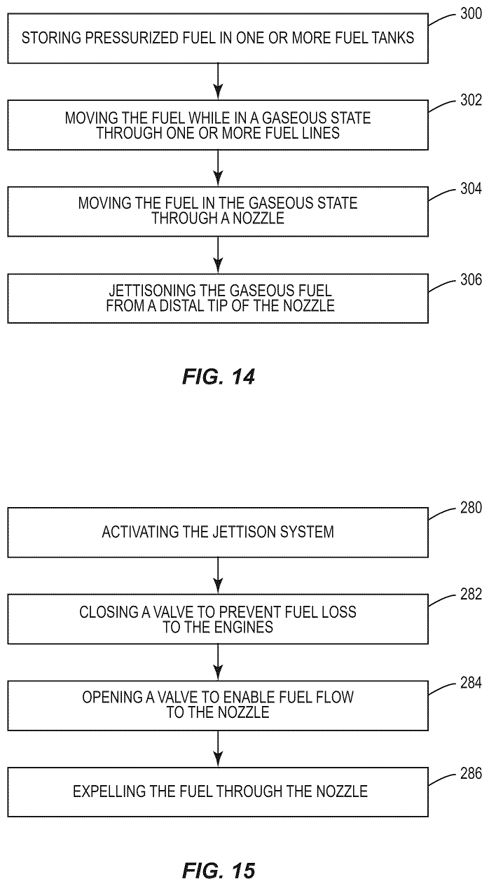

FIG. 15 illustrates another method of jettisoning fuel from an aircraft 100. The method starts by activating the jettison system (block 400). In some examples, this receives through a command from the flight deck 102. In some examples, the activation occurs based on a sensor reading, such as a fire detection sensor that is located on the aircraft 100.

Activation of the jettison system 20 causes a valve 27 to close to prevent fuel from being pulled from the engines 104 (block 402) In one example as illustrated in FIG. 5, this includes valve 27a to close. After a delay (e.g., 3 seconds, 5 seconds, 10 seconds), another valve 27 along the fuel line 21 openings to allow fuel to flow through the nozzle 22 (block 404). In the example of FIG. 5, this includes valve 27b. The fuel is then moved along and is expelled through the nozzle 22 (block 406).

In some examples, the fuel is ignited as it is expelled from the aircraft 100. In other examples, the fuel remains in gaseous form. In some examples, opening a valve at the fuel tanks 90 enables the fuel to flow along the fuel lines 21 due to the pressurized fuel moving towards the ambient pressure at the nozzle 22. In some examples, activation of the jettison system 20 causes the actuator 25 to enable the nozzle 22 to move to the deployed position.

The jettison system 20 can be used on a variety of different vehicles. Examples of other vehicles include but are not limited to manned aircraft, unmanned aircraft, manned spacecraft, unmanned spacecraft, manned rotorcraft, unmanned rotorcraft, satellites, rockets, missiles, manned terrestrial vehicles, unmanned terrestrial vehicles, manned surface water borne vehicles,, unmanned surface water borne vehicles, manned sub-surface water borne vehicles, unmanned sub-surface water borne vehicles, and combinations thereof.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A system to jettison fuel from an aircraft, the system comprising:
one or more fuel tanks positioned within one or more of a fuselage and wings of the aircraft and that are configured to contain the fuel in a pressurized state;
fuel lines that extend from the one or more fuel tanks within one or more of the fuselage and the wings of the aircraft, the fuel lines configured to move the fuel while in a gaseous state; and
a nozzle connected to one of the fuel lines, the nozzle comprising a passage that moves the fuel along a length of the nozzle and out through a distal end of the nozzle.

2. The system of claim 1, wherein the nozzle is movable between a stowed position with the distal end positioned in proximity to the aircraft and a deployed position with the distal end extending outward away from the aircraft.

3. The system of claim 2, further comprising a receptacle positioned on an exterior of the aircraft and sized to contain the nozzle in the stowed position for the nozzle to be out of an airflow during flight.

4. The system of claim 2, wherein the fuel lines extend to one or more engines mounted to the aircraft with the one or more engines configured to propel the aircraft during flight.

5. The system of claim 2, further comprising a drag bar mounted to the nozzle with the drag bar comprising one or more surfaces that are contacted by airflow and cause the nozzle to move to the deployed position during flight of the aircraft.

6. The system of claim 1, further comprising an igniter positioned at the distal end of the nozzle, the igniter configured to ignite the fuel at the distal end of the nozzle.

7. The system of claim 1, wherein the one or more fuel tanks store the fuel in the pressurized state that is at least twice ambient pressure.

8. The system of claim 2, further comprising:
a spring that applies a biasing force to the nozzle to bias the nozzle towards the deployed position;
a latch that engages with the nozzle to maintain the nozzle at the deployed position; and
an actuator configured to release the latch to enable the biasing force of the spring to move the nozzle to the deployed position.

9. The system of claim 1, further comprising one or more valves located along the fuel lines with each of the valves configured to be movable between a closed position and an open position to control a flow of the fuel through the fuel lines.

10. A system to jettison fuel from an aircraft, the system comprising:
one or more fuel tanks configured to store pressurized fuel;
a nozzle mounted to the aircraft and comprising an elongated length that terminates at a distal end of the nozzle;
fuel lines that distribute the fuel through the aircraft with the fuel lines extending between the one or more fuel tanks to one or more engines that propel the aircraft during flight and to the nozzle;
an actuator connected to the nozzle and configured to enable the nozzle to move from a stowed position with the distal end located in proximity to the aircraft and a deployed position with the distal end located away from the aircraft to eject the fuel away from the aircraft; and
an igniter positioned at the nozzle to ignite the fuel that is being ejected from the nozzle.

11. (canceled)

12. The system of claim 10, wherein the actuator is a pneumatic actuator that comprises a housing and a plunger and wherein the one of the fuel lines is connected to the housing to move fuel into an interior of the housing to move the actuator between a first position to locate the nozzle in the stowed position and a second position to locate the nozzle in the deployed position.

13. The system of claim 10, wherein one of the fuel lines that is connected to the nozzle comprises a kink with an angle and wherein the fuel line is configured to straighten the kink and increase the angle when the fuel moves through the kink and apply a force to move the nozzle from the stowed position to the deployed position.

14. The system of claim 10, wherein the one or more fuel tanks and the fuel lines are configured to contain the fuel in a gaseous state.

15. The system of claim 10, further comprising:
one or more regulators located on the fuels lines to control the fuel that is supplied to the engines; and
one or more valves located on the fuel lines and selectively positionable to control a flow of the fuel that moves along the fuel lines.

16. The system of claim 10, wherein the system is configured to move the fuel along the fuel lines through pressure and without a fuel pump.

17. A method of jettisoning fuel from an aircraft, the method comprising:
storing pressurized fuel in one or more fuel tanks that are positioned within one or more of a fuselage and wings of the aircraft;
moving the fuel while in a gaseous state through one or more fuel lines that extend through one or more of the fuselage and the wings of the aircraft;
moving the fuel in the gaseous state through a nozzle that is attached to the aircraft; and
jettisoning the fuel in the gaseous state from a distal tip of the nozzle and away from the aircraft.

18. The method of claim 17, further comprising igniting the fuel in the gaseous state while the fuel is being jettisoned from the distal tip of the nozzle.

19. The method of claim 17, further comprising moving a portion of the fuel into an actuator that is operatively connected to the nozzle and moving the nozzle from a stowed position to a deployed position.

20. The method of claim 17, further comprising jettisoning the fuel in the gaseous state from one of a fuselage and a wing of the aircraft.

21. The system of claim 10, further comprising a receptacle positioned on an exterior of the aircraft and sized to contain the nozzle in the stowed position for the nozzle to be out of an airflow during flight.
